(19) United States
(12) Patent Application Publication
(10) Pub. No.: US 2008/0252062 A1
(43) Pub. Date: Oct. 16, 2008

(54) DYNAMIC DOUBLE CREASE OR DOUBLE SCORE BOOKLET

(75) Inventor: Timothy J. Kelley, Fairport, NY (US)

Correspondence Address: OLIFF & BERRIDGE, PLC., P.O. BOX 320850, ALEXANDRIA, VA, 22320-4850, US

(73) Assignee: XEROX CORPORATION, Stamford, CT (US)

(21) Appl. No.: 11/735,758

(22) Filed: Apr. 16, 2007

(51) Int. Cl. B42D 1/00

(52) U.S. Cl. 281/21.1

(57) ABSTRACT

A method for making a multi-page document including one or more sheets and a cover, including receiving instructions to crease or score one or more of the one or more sheets at at least two different and parallel locations on the sheets and cover, wherein the instructions provide a distance between each of the at least two creases or scores as well as a distance of each crease or score from a middle of the sheets and cover, pre-creasing or pre-scoring the sheets and a cover with the at least two or more creases or scores at the locations, and folding the sheets and cover at each crease or score location.

### BACKGROUND

Booklets are used as an alternative to bound books because they can be made very quickly at a fraction of the cost. Today, a variety of different booklet systems can deliver professional documents, including books, manuals, publications, annual reports, newsletters, business plans, and brochures. As printers become more sophisticated and less expensive, customers are designing booklets and booklet covers that are full of color and text.

Scoring and creasing are essential processes in booklet making. Currently, in processes for booklet making, a booklet is scored or creased directly in the middle once it is finished and stitched. This type of booklet is referred to as a saddle-stapled booklet. The booklet is usually held together by one or more staples that are driven along a centerline of two or more different printed sheets. Upon folding a booklet that contains a larger number of pages, a trimming process is needed to make the edges of all of the pages flush and therefore uniform.

Unfortunately, unlike a perfect bound book that has a flat spine, as the number of pages increase in a saddle-stapled booklet, undesired raised areas or “pillowing” is commonly located near the crease or score, which is a result from the increased number of pages included in a booklet. Further, with single, centered creasing, subsequent squaring off in a squaring unit to attempt to create a flat spine via force is problematic and results in a non-aesthetically pleasing booklet. Furthermore, as a result of an increased number of pages, any toner that is applied in the area of the fold and raised areas on the cover of the booklet tend to crack, which creates an undesirable look.

### SUMMARY

It is apparent from the above that there exists a need in the art for a method and apparatus that is capable of creating a booklet with similar features of a perfect bound book, and eliminating the cracking of toner. For example, it is desired to develop a process for making booklets that may be more readily squared with a pleasing appearance. These and other objects are achieved herein by providing a double crease/score on sheets, as well as a cover, of pages to be included in the booklet.

In embodiments, described is a method for making a multi-page document including one or more sheets and a cover, including receiving instructions to crease or score one or more of the one or more sheets at at least two different and parallel locations on the sheets and cover, wherein the instructions provide a distance between each of the at least two creases or scores as well as a distance of each crease or score from a middle of the sheets and cover, pre-creasing or pre-scoring the sheets and a cover with the at least two or more creases or scores at the locations, and folding the sheets and cover at each crease or score location.

In further embodiments, described is a production and finishing apparatus for making a multi-page document including one or more sheets and a cover, including a production device for producing documents, a controller, and a finishing module for applying a plurality of parallel creases or scores in one or more of the one or more sheets and the cover, binding the cover and sheets, and folding the cover and sheets at each crease or score location.

### BRIEF DESCRIPTION OF THE DRAWINGS

FIG. 1 is a block diagram of a flow of work in accordance with the present disclosure.

FIG. 2 is a block diagram illustrating a relation between a controller and database in accordance with the present disclosure.

FIG. 3 is an illustrative example of a saddle-stapled booklet.

FIG. 4 is an illustrative example of a double crease/score booklet.

FIG. 5 is an illustrative example of creases/scores being placed at desired locations.

### EMBODIMENTS

For purposes of the present disclosure, the following shall apply:

A “crease/score” refers to, for example a crease or a score. Embodiments of the present disclosure are capable of providing a crease or a score lo a cover or sheets. Therefore, for readability, a crease/score refers to each a crease or a score. In this regard, a score typically refers to the result of a hard tool being run along a selected line of a substrate, while a crease typically refers to the result of pressing a hard tool into the selected area/line of a substrate.

A “document component” refers to, for example a collection of one or more sequential sheets of media that have similar qualities or characteristics and thus would be printed or non-printed and would be finished or produced in a similar manner. Examples of document component types are covers, bodies and inserts. When collected together in a specific order, a collection of document components may form a complete “document.” Each document component may require its own intermediate finishing operation before its final assembly/finishing into a “document.” For instance, a cover sheet may require lamination in an intermediate finishing process before conveyance to the final assembly/finishing apparatus.

A “booklet” refers to, for example a collection of one or more document components placed in a specific order and bound together.

A “cover” refers to, for example, the outermost sheet of a booklet. The cover may be, for example, a paper or laminated sheet, plastic, cardboard, and the like. The cover may be comprised of the same materials as other sheets of the booklet.

A “document form” refers to, for example, the manner in which the various document components are finished into a composite form, including such operations as folding, cutting, stitching, binding, and gluing. Each document form requires unique image imposition, printing, finishing process requirements and physical identifying characteristics. An example of a “document form” is a “perfect bound,” wherein individual sheets of media grouped together that are commonly glue-bound to a flexible, wrap-around cover which protects the body/contents. The edges of the book-block and cover are usually flush with each other creating a flat spine.

A “constraint” refers to, for example, a limitation of a device based upon its design or use. A “constraint” may be permanent or temporary. Examples of permanent constraints would be inflexible bin heights or widths, temperature limits for laminators, bin type (set feeder or sheet feeder), method of feed (for example, top or bottom feeder), required order (n-to-1 or 1-to-n), face up, face down, required orientation (for example, leading edge must be long or short dimension), paper path width, thickness for folding and trimming, transformations enabled within the device (for example, face up to face down, lead-edge reversal to trial-edge), landscape to portrait orientation, and the like) and similar limits related to a device's design. Examples of temporary constraints include: a period of time that a piece of equipment or part of equipment, such as a particular bin, is not available due to a broken part or use for another job; or (b) the type of media, glue, binder material, and the like, then available for use within a particular piece of equipment.

A “job segment” refers to, for example, a stack of sheets produced by a common printing or finishing process and conforming to the same printing and finishing constraints. A “job segment” may contain a single document component, a portion of a large document component, or a collation of several document components. As will be explained below, “job segments” are identified in order that document components with similar printing and, or finishing requirements are grouped together for efficient printing, handling, and finishing. For example, if a document has two 8.5″×11″ monochrome body components, both body components may be grouped in the same job segment in order that they will be printed on the same printer at the same time. Depending upon requirements, these components may be output at the printer as collated or non-collated stacks and, if the components are collated, the collated stacks may be placed in an offset manner in order to indicate separation between the collated sets. As another example, if an input bin of the selected finishing apparatus has a stack height constraint of 2.2 inches, then the maximum stack height of a “job segment” will be 2.2 inches even if the total stack height of a particular document component or of a collated stack of components is much higher. For this situation, a “sob segment” during printing may comprise all of the sheets that are printed at the same printer. Within this large job segment stack, however, smaller “job segments” limited to 2.2 inches in height may be separated in an offset manner or separated by separator sheets. Thus, segmentation of a job would be done based upon an offline finishing constraint that does not otherwise affect the operations of the printer system.

As used herein, “finisher” and “assembler/finisher” both refer to, for example, systems designed to perform assembly and/or finishing operations.

Creation and production of booklets often involves many production and finishing operations that are highly variable with each job. In general, the various operations can be grouped into three major phases: 1) creation of booklet information, 2) printing of the information onto some form of media such as paper, and 3) finishing of the selected media into a completed booklet. These three major phases often have many sub-phases, and the entire process may vary from relatively simple to extremely complex. The present disclosure deals with techniques by which a user may provide detailed instructions for each of the three phases, such that instructions may be created as early as during the first phase that are sufficient to guide the entire process through to completion of the third phase. Although of potential use in many printing operations, the present disclosure is applicable to automated systems for creating, printing, and finishing booklets within a single or a multi-printer, completely digital environment using one or more digital printers.

Traditionally, when a document is composed, a person performing the composition will create one or more electronic image files that represent the parts of the booklet to be produced, such as the individual pages and cover. These electronic image data files may be stored in many different formats by many different document creation and manipulation programs. For instance, for a complex document such as a booklet that utilizes color printing for covers and pictorial inserts, any of a variety of Page Description Languages (PDLs), such as Postscript® and Postscript-compatible languages, may be used to render the color images in printable form. Other workflows such as job definition format (JDF), portable document format (PDF) or document finishing, architecture (DFA) may also be used.

Often, different components within a document will utilize different PDLs. For instance, the cover may be created by a different work team or upon different equipment than photographic reprints or other internal color components. For pages comprised of simple monochrome text, desktop publishing programs may be utilized to render such pages or a simpler word processing language may be utilized. Still other prepress formats may be utilized for printing of inserts, dividers, and other possible components internal to the finished document. There also may be included in the assembly/finishing job non-printed components such as, without limitation, plastic separators, previously printed sheets retrieved from inventory, photographically produced sheets, or specialized media such as vinyl disk holders or perfume sample packs.

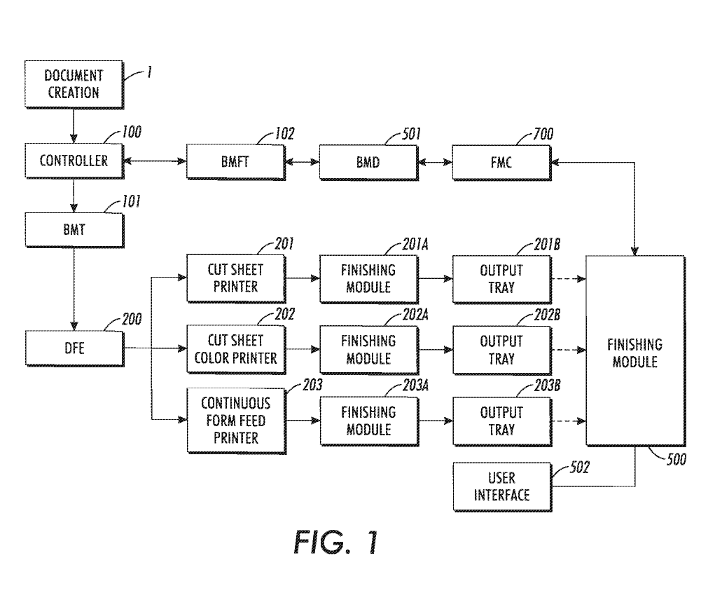

Turning now to FIG. 1, an overview of an, embodiment of the present disclosure is shown. FIG. 1 contains a block diagram showing the flow of work and showing some of the relationships between various items of equipment in accordance with embodiments of the present disclosure. For completeness, the flow of work from printing individual sheets of a booklet to the actual formation of the booklet will be described below. However, one of ordinary skill in the art will appreciate that previously printed sheets and or covers may be inserted at, for example, finishing module 500, thus skipping the creation and printing process steps. Further, a pre-collated set is described herein. However, finishing may be preformed on a sheet level utilizing finishing devices to compile/collate into a set, and pre-collation is not required. Within FIG. 1, box 1 represents a prepress operation. The output of the prepress operation box 1 is a set of appropriate PDL files that are delivered to a controller 100. As described more fully below, the controller 100 coordinates overall production of booklet making.

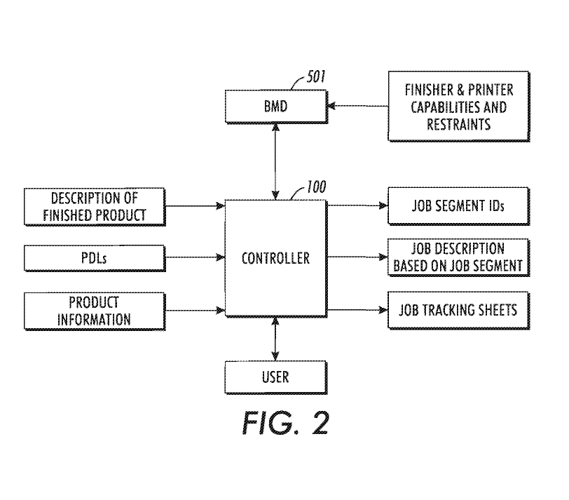

FIG. 2 shows the typical inputs and outputs of controller 100 in block diagram form, including the relationship between controller 100 and a booklet making database (BMD) 501, described below. In general, the inputs to controller 100 include some or all of: 1) from BMD 501, a list of printer capabilities and constraints; 2) from BMD 501, a list of assembler/finisher capabilities and constraints; 3) a description of the finished product; 4) PDLs and other files for the content of each sheet and/or cover to be printed; 5) production information such as the number of copies, targeted printing devices, and any special finishing or packaging attributes, including, without limitation, the identity and retrieval location of any non-printed anchor inventory items as well as information, as to what type of booklet is to be made, for example, saddle-stapled, double crease/score. In general, the output from the controller 100 includes identification of each job segment for each operation within the job as well as a complete set of assembling/finishing instructions for each job segment. More specifically, the output from the controller 100 comprises some or all of: 1) job segment descriptions and identifiers for each job segment: 2) a database representation (such as BMD 501) of the structure of the job segments and the document components, sheets or sets within the job segment; 3) a PDL file for a job tracking sheet, if any; 4) a PDL for a fetch sheet, if any; 5) integrity descriptors encoded into BMD 501 for later use by a Finishing Module Coordinator (FMC); 6) booklet making tickets for printers and assembler/finishers; and 7) a prompt to call for one or more human operator responses.

Returning to FIG. 1, an instruction set for assembling/finishing is output from controller 100 in the form of both a booklet making ticket (BMT) 101, and a booklet making finishing ticket (BMFT) 102. BMFT 102 and BMT 101 may contain the complete instruction set for the job or may simply contain reference pointers to a database where such information is retained. Instructions may include the style of booklet, for example, a saddle-stapled or double crease/score booklet.

The data for each BMFT is recorded by controller 100 in BMD 501. The BMD 501 is a database or a data file that contains all job construction, control and integrity data necessary to take the prints coming from the printing device(s) and perform the necessary finishing processes to turn the prints into the desired final booklets. In embodiments, the format of BMD 501 can be hard copy (print), soft copy (floppy, CD-R, CR-RW) or electronic (electronically stored in memory or on a hard disk drive) copy form. In further embodiments, the format of BMD 501 could be either human or machine-readable or both.

The type of data and instructions required in BMD 501 for each job are information such as but not limited to: accounting and administration information, number of sheets, set and job level finishing instructions, color and print quality control data, registration data, and the like. The data and instructions also contain a description of the job segments (stacks and stacks of sets) of the job being produced and instructions on how to reassemble these pieces to complete the processing of the job. Additionally this information can enable the automatic setup of the finishing device(s) integrity control and monitoring throughout the full scope of the production processes.

The printing process is commenced after delivery of the BMT 101, to one or more digital front-end print controllers (DFE) represented by box 200. In conformance with instructions provided in BMT 101, the print job is divided into separate printing job segments and may be distributed to various print engines for printing using the printer or press which the operator or controller 100, believed to be optimal when BMT 101 was first established. Alternatively, BMT 101 may provide that the DFE 200, sometimes through interaction with controller 100, may automatically select the appropriate printing device based upon dynamic queue and print selection criteria.

Boxes 201-204 of FIG. 1 are examples of various types of printers to which document components may be delivered for printing. Printer 201 may be a cut sheet digital printer connected to an optional integrated finishing module 201A. A typical finisher module 201A includes capabilities such as collation, folding, and simple binding such as stapling discussed in further detail below with respect to finishing module 500. Printer 202 may be a cut sheet printer with a combination of color and monochrome printing capability. The DOCUMENT CENTRE® COLOR SERIES 50 printer sold by Xerox Corporation is such a printer. Finisher module 202A is integrated with printer 202 as shown in FIG. 1 and may have capabilities similar to that described in connection with finisher 201A. Similarly, printer 203 is shown as a continuous form feed printer and is integrated with finisher module 203A.

Each of finishing modules 201A-203A place their respective job segments in their respective output trays or bins 201B-203B. When placed in such trays or bins, the job segments may not be collated, stacked or otherwise separated for handling and conveyance. Also as mentioned above, each of finishing modules 201A-203A may provide some intermediate level of finishing such as folding or stapling. Multiple document components nay be printed or assembled at the same printer and intermediate finishing station and be treated during this phase of the job as one job segment. Conversely, a single large document component may be output in a stack with separator sheets or offset stacks indicating multiple job segments within the single document component.

The last phase of the printing process comprises an optional final assembly and finishing phase wherein the various document components are gathered from output trays or bins 201B-203B, assembled in a particular order, and finished into a specified document form. In FIG. 1, arrows 301A, B and C show the conveyance of printed job segments from output trays or bins 201B-203B to finishing set feeder module 500. In conventional systems, such conveyance may be manual or automated. As mentioned above, the steps of creation and printing may not be needed and therefore can be skipped. In such cases, a user may begin the process of making a desired booklet starting with finishing feeder module 500.

Optionally, a unique Job Segment Identifier (JSI) may be associated with each job segment. In FIG. 1, a sheet containing a JSI is may be printed in association with each job segment that is output from printers 201-204. In embodiments, for complex jobs or for document components that are printed in large stacks, there may be many JSIs corresponding to many job segments within the job or within the stacks.

A JSI can assume any form that can be associated with a job segment throughout the finishing and other applicable printing processes. Among such forms are copies stored in (a) a printed sheet printed and placed on top of a printed job segment, (b) system memory such as hard drives, (c) magnetic media such as floppy disks or magnetic strips, (d) optical memory such as CD-ROM or CR-RW disks, (e) bar code symbols printed on sheets associated with the Job Segment, or (f) any other means by which machine or human readable identifying information may be associated with a Job Segment. A JSI may be machine, human readable, or both depending upon the phase of the job. In the event that a scanner is capable of reading the top printed page of a job segment in such manner that the job segment can be uniquely identified, then no special symbols or special top page would be necessary. Thus, each JSI contains, at a minimum, a job and job segment number or other identifier that uniquely identifies the job segment from all other job segments. Typically, the JSI comprises both a unique job number and a Job Segment Identifier Code (JSIC). The job number uniquely identifies the print job from all other print jobs and the JSIC uniquely identifies the job segment. In embodiments, the JSIC comprises recognizable unique text on the top sheet of a job segment. Whichever form a JSI takes, the JSI serves as a reference pointer to the portion of the BMD that describes the contents of the identified job segment. The JSI remains associated with the applicable job segment when it is transported from the printing device(s) to other finishing processes. This enables tracking of the job segment from the printing device(s) to an assembler/finisher apparatus. Whether or not the job segments are part of a job that requires prints to be produced on one or more printing devices), each JSI will have a common job number but a different JSIC that uniquely identifies each particular job segment of the job.

As mentioned above, JSIs may be in the form of a printed sheet called a Job Segment Identifier Sheet (JSIS) that is typically printed along with the sheets of the job and is placed on top of the job segment stack in the output trays or bins, 201B-203B. Information on a JSIS comprises either (a) a pointer (the job number and JSIC) to the BMD stored in some other electronic or soft copy format or (b) the portion of the BMD itself that provides instructions for the job. Such instructions may be printed on the JSIS in electronic or human readable form in contrast to conventional separator sheets that are placed upon each stack of printed output no matter how large the stack, each JSI serves as a unique identifier of each job segment of a print job.

A job segment may arrive at finisher module 500 with a JSI reference pointer, or, as mentioned above, a user may begin the process at finisher 500 with pre-printed sheets and/or cover. In this instance, a user may utilize user interface 401, which may be separate from or integrated into finisher module 500. The user may then provide finisher module 400 with instructions for the completion of a desired booklet, for example, desired number of pages, type of media to be used in each sheet and/or cover saddle-stapled or double crease/score booklet and the like. As noted above, this information typically will appear on a JSIS although any form of JSI will suffice. The purpose of the JSI is to identify a particular job segment to a finishing module controller 700, which is a controller of the present disclosure that directs the assembler/finisher operations. In FIG. 1, a Job Ticket Reader (JTR) is shown as 701 and is responsible for reading the JSIS or for otherwise providing information to the FMC 700, sufficient for the FMC to determine the unique JSIC. Humans may also intervene in the process to submit JSIC's to the FMC, particularly if a JSIS is only human readable. This may be done through user interface 502.

The FMC 700 is a software-based controller that manages, interprets, sequences, and allocates assembler/finisher production data. Using a variety of interfaces to each assembler/finisher device, the FMC communicates to each device the data required to program that device for implementation of the job. It tracks each job segment through the process and ensures that job segments are properly loaded before the devices begin operating. The FMC also typically provides information to human operators concerning job status and in order to enable operators to make production decisions where necessary or appropriate. The FMC operates by receiving the JSI, or information directly from user interface 502, that identifies each job segment and determining whether the JSI itself contains all required assembler/finisher data. If a JSIS or similar JSI does not provide all instructions for finishing the job, then the FMC uses the JSIC to retrieve all relevant information concerning the job model stored in BMD 501. FMC 700 then reviews the assembler/finisher combinations prepared by controller 100 to ensure that all identified devices are currently available. Once this condition is satisfied, then FMC 700 determines the bins or other assembler/finishing locations where each job segment should be placed. In general, FMC 700 communicates with controller 100 through BMD 501. Where assembler/finisher devices are automatically programmable, FMC 700 typically is programmed to interact with the specified interface format for each device in order to automatically provide programming instructions. Job tracking and integrity information would also be provided. When all required job segments have been loaded in their appropriate bins, FMC 700 will either direct the assembler/finisher devices to begin or inform human operators that the job is ready. In this manner, the complete assembler/finisher operation can be controlled, implemented, tracked, and checked for integrity. More details concerning the design and operation of the FMC is provided below. For purposes of clarity, it is important to note that the functions of controller 100 and FMC 700 are described as separate controller functions. It is possible for these controllers to be combined or for some functions described in relation to one controller to be reallocated to the other controller.

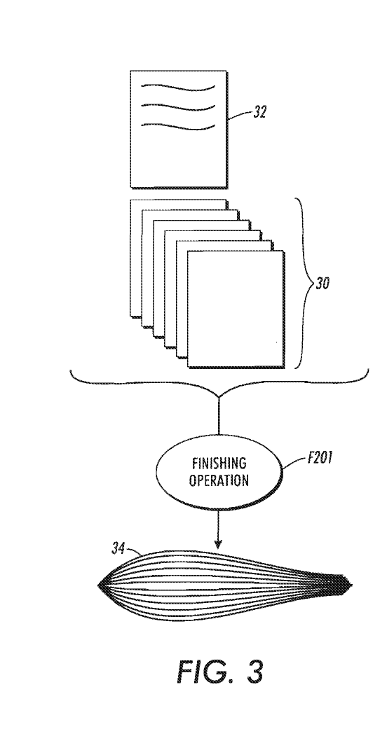

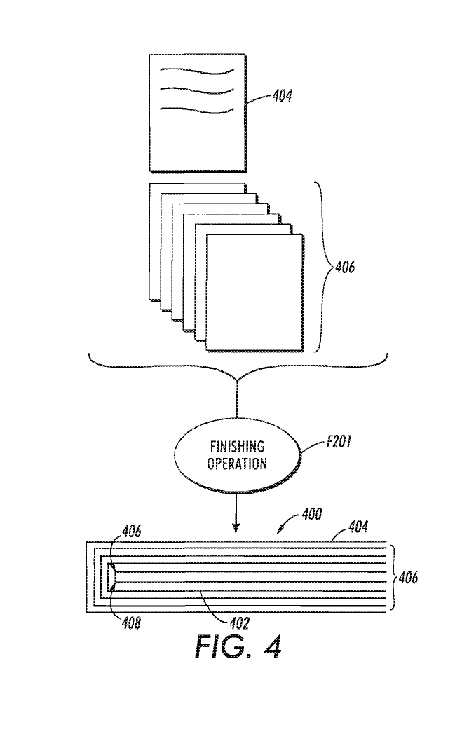

Examples of booklets with different components and levels of complexity will now be shown by reference to FIGS. 3 and 4. The processes described below are capable of being performed in finisher modules 201A-C and finisher module 400. For clarity, the processes performed below will be in reference to finishing operation F201 and F202, each of which may be performed in finisher modules 201A-C and finisher module 400 described above.

Beginning in FIG. 3, a simple saddle-stapled booklet is shown that comprises a body 30 and cover 32. The body 30, as mentioned previously, may be comprised of printed or non-printed components such as, without limitation, plastic separators, previously printed sheets retrieved from inventory, photographically produced sheets, or specialized media such as vinyl disk holders or perfume sample packs.

After the body of a booklet is gathered and in a proper order, the cover 32 is placed on top. Finishing operation F201 performs a folding process and a cover-bound document 34 is created as shown to the right of finishing operation F201. However, as mentioned above, a saddle-stapled booklet that contains a single crease/score may be undesirable due to, for example, pillowing and toner cracking. Therefore, the present disclosure provides a user with the option of creating a double crease/score booklet, the process of which is now described in detail.

With reference now to FIG. 4, a double crease/score booklet (DCB) is referenced generally by numeral 400 and comprises a cover 404 and a body 406, which includes one or more sheets 402. As can be seen, DCB appears very similar to a perfect bound book in that the spine is flat. This is due to the double crease/score placed on the cover 404 and optionally placed on the entire body 406. In embodiments, all of the sheets 402 of the booklet, and including the cover 404, are pre-creased/scored with at least two parallel creases/scores. In other embodiments, it may not be necessary to double crease/score one or more sheets 402 at the center of the booklet, and for these center sheets, a single crease/score, or no crease/score, may suffice. Thus, in these embodiments, at least the sheets away from the center of the booklet and toward the cover, as well as the cover, are pre-creased/scored with at least two parallel creases/scores.

In embodiments, more than two creases/scores may be placed on the cover and/or each sheet. For example, four creases/scores may be provided, for example in instances where two creases/scores surround each fold location. This may be advantageous, for example, four a cover of a larger booklet, where double creasing/scoring each corner can provide a nice fold.

As mentioned above, a double crease/score booklet provides many advantages over a saddle-stapled booklet. For example, a double crease/score booklet contains a cover that is flat on top and bottom as well as the spine. Therefore, no matter how many pages are within the body of the booklet, users will be provided with a more aesthetically appearing booklet compared to a saddle-stapled booklet and at a lower cost of a perfect bound book. Further, the double creases/scores allow for printed text not to be caught within a fold and removed by folding.

As shown, sheet 402 is folded at crease/score 406 and at crease/score 408. Each sheet and cover is pre-scored/creased at fold locations before they are bound together. That is, during finishing operation F202, each sheet and cover is provided with two creases/scores. The sheets and cover are then bound together and folded. Pre-creasing/scoring the sheets and cover allow for an easier and much more precise fold.

However, upon folding, a sheet on the outside of a fold is wrapped around all the other sheets thus making this page shorter than a page in the middle of the fold. Therefore, the more sheets a booklet contains, the more non-uniform the edges may be. To correct this issue, a trimming process may be performed.

Further, as mentioned previously, double creasing/scoring the cover decreases the likelihood of toner cracking. That is, toner placed on the cover will not be subjected to extreme folds or raised areas in a DCB compared to that of a saddle-stapled booklet. Currently, toner is placed over the entire cover of a booklet with a user not knowing exactly where a fold in the cover may be. Thus, if toner cracks, not only will this make the cover less attractive, the cracking may take place in a location that contains text or an image, leading to a lower quality appearance.

As can be seen in FIG. 4, creases/scores 406 and 408 of inner sheet 402 are not as far apart as creases/scores 410 and 412 placed on cover 404. This is due to the fact that as the number of sheets within a booklet grow, the distance between the individual creases/scores needs to grow as well in order for the booklet to fold properly. That is, sheets at the innermost part of the booklet will have smaller distances between creases/scores, while a cover will have the greatest distance between each crease/score. In order to determine the proper distance between each crease/scores, finishing operation F202 may include a tool that dynamically grows the spacing between creases/scores with the sheet count. This tool may move mechanically or be digitally controlled, for example with servos. An equation (D×N) may be provided where N equals the number of an individual sheet, for example with respect to a center of the booklet, and D equals some distance from the center of each sheet that each crease/score will be. A distance D may either be preprogrammed in finishing operation F202, or may be provided by a user. Here, for exemplary purposes, D is set to 1 mm, D may be preset based on, for example, a thickness of the material used in forming the sheets of the booklet.

For example, with reference to sheet 402, sheet 402 is the second innermost sheet in booklet 400. Therefore, N=2 for sheet 402. When applying the equation to sheet 402, the distance between crease/score 406 and 408 would be 4 mm. That is, (D(1 mm)×N(2))=2 mm. Thus, in this example, each crease/score will be 2 mm from the center of the sheet and therefore 4 mm from each other. As the sheet count grows, so does the distance between the creases/scores on each sheet, and ultimately on the cover.

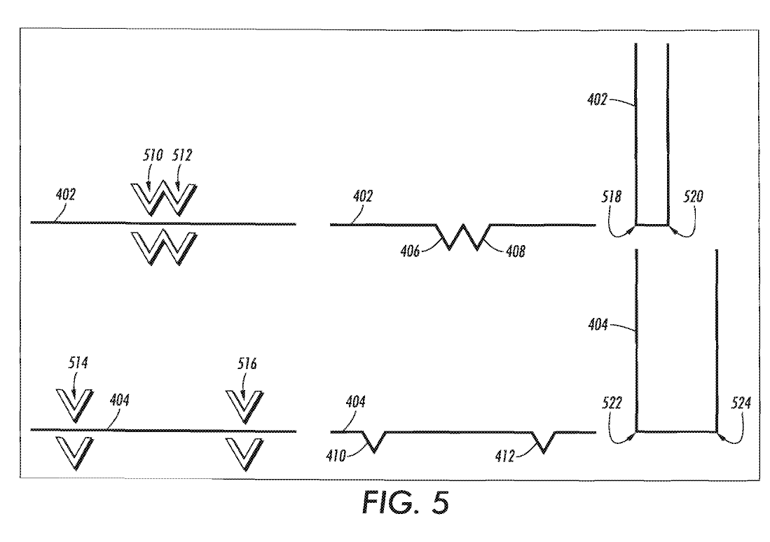

With reference now to FIG. 5, an illustrative example of creases/scores being placed at desired locations on sheet 402 and cover 404, shown flat for clarity. The location of each crease/score that will be placed on sheet 402 are represented by reference points 510 and 512. As mentioned above, sheet 402 will contain creases/scores that are closer together than cover 404. Therefore, the location of each crease/score that will be placed on cover 404 are further apart and are represented by reference points 514 and 516.

Referring back to FIG. 4, finishing operation F202 places two creases/scores at the determined locations of a given sheet using a crimping blade or roller device. For example, as described in U.S. Patent Publication No. 2006-0245781 herein incorporated by reference, a blade in conjunction with crease rolls is used to effect the creasing. After the creases are placed on all of the individual sheets and/or cover, finishing operation F202 then binds the pieces together using, for example, one or more staples, and folds the sheets and cover at desired crease locations.

With reference now to FIG. 5, an example of each crease/score being placed on sheet 402 and cover 404 is shown at creases/scores 406 and 408, with respect to sheet 402 and at creases/scores 410 and 412 with respect to cover 404. These creases/scores may be formed by, for example, a crimping blade. For completeness, reference points 518 and 520 on sheet 401 and reference points 522 and 524 on cover 404 represent the location of creases/scores 406, 408, 410 and 412, respectfully, illustrating the fold that occurs at each crease/score.

As mentioned above, it is within the capabilities of the present disclosure for a user to provide a desired distance between either each crease/score on each sheet, or at least the cover. For example, say a user would like a certain size text to be placed on the spine of a cover and this specific size text needs to have a certain amount of space. However, using a pre-programmed formula, like the one described above, may not provide a cover with a necessary distance between each crease/score, and therefore between each fold, and the spine will be too thin for the desired text. The user may provide finishing operation F202 with a desired distance between the creases/scores on the cover. The system may then automatically calculate a growth factor from a center sheet. The pages between the cover can then be altered to have a distance that provides a more uniform look taking into consideration the distance between the creases/scores on the cover.

In embodiments, a user may enter a desired text and text size at document creation 1 or at user interface 502. Once a user has entered this information, the user may be provided with a message stating that the desired text will not fit on the spine of the booklet cover under the current default settings. The current default settings, which may include a pre-set distance for each crease/score on each sheet anchor cover, may be pre-programmed by the user or set by a manufacturer. The user may then define a distance for each sheet, or just for the cover in order for the desired text to fit, or the system may alter the distances between each crease/score based on the desired text the user wishes to have placed on the spine of the cover. The cover, and sheets if necessary, will then be pre-creased/scored by finishing operation F202.

In further embodiments, a user may enter a desired growth factor. The system may automatically apply this growth factor from a center sheet. Or, a user may enter paper characteristics into a user interface, allowing the system to automatically determine needed distances between each crease/ score based on the provided information. One of ordinary skill will appreciate that many different scenarios, like the one just described, are within the capabilities of the present disclosure and thus will not be further described herein.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. A method for making a multi-page document including one or more sheets and a cover, comprising:
receiving instructions to crease or score one or more of the one or more sheets at at least two different and parallel locations on the sheets and cover, wherein the instructions provide a distance between each of the at least two creases or scores as well as a distance of each crease or score from a middle of the sheets and cover;
pre-scoring or pre-creasing the sheets and a cover with the at least two or more creases or scores at the locations; and
folding the sheets and cover at each crease or score location.

2. The method of claim 1, wherein the distance between each of the at least two creases or scores is adjusted by a sliding tool.

3. The method of claim 2, wherein the sliding tool is adjusted by servos.

4. The method of claim 1, wherein the distance between each of the at least two creases or scores of the sheets and cover is provided by a user.

5. The method of claim 4, wherein the user enters the desired distance in a user interface.

6. The method of claim 1, wherein only two creases or scores are provided on each sheet of the plurality of sheets and cover.

7. The method of claim 6, wherein the distance between locations of the at least two creases or scores is increased by a growth factor for each sheet as one moves further away from a center of the document and toward the cover of the document.

8. The method of claim 7, wherein a user enters a spine thickness and the growth factor is automatically determined from a center sheet.

9. The method of claim 7, wherein a user enters the growth factor and the growth factor is automatically applied.

10. The method of claim 7, wherein a user enters paper characteristics and the growth factor is automatically determined and applied based on the paper characteristics.

11. The method of claim 7, wherein the distance between locations of the at least two creases or scores is increased by N×D, wherein N equals a number of an individual sheet, and D equals a distance from a center of each sheet that each crease or score will be located.

12. The method of claim 1, wherein prior to folding, the one or more sheets and cover are assembled in a desired order.

13. The method of claim 1, wherein the sheets and cover are bound with one or more staples.

14. The method of claim 1, wherein one or more sheets and/or the cover include two creases or scores at each fold location.

15. A production and finishing apparatus for making a multi-page document including one or more sheets and a cover, comprising:
a production device for producing documents;
a controller; and
a finishing module for applying a plurality of parallel creases or scores in one or more of the one or more sheets and the cover, binding the cover and sheets, and folding the cover and sheets at each crease or score location,

16. The production and finishing apparatus of claim 15, further comprising a sliding tool in the finishing module that sets a desired location of distance between each of the plurality of creases or scores for providing two or more parallel creases or scores appropriately spaced apart from each other.

17. The production and finishing apparatus of claim 15, wherein the plurality of creases or scores are made with a roller.

18. The production and finishing apparatus of claim 15, wherein the creases or scores are made with a blade.

19. The production and finishing apparatus of claim 15, wherein the sheets and cover are bound with staples.

20. The production and finishing apparatus of claim 15, wherein the production device is separate from the finishing module.
